(19) United States
(12) Patent Application Publication
(10) Pub. No.: US 2011/0011091 A1
(43) Pub. Date: Jan. 20, 2011

(54) Method to create kinetic energy

(76) Inventor: Thomas A. Gardner, Littleton, CO (US)

Correspondence Address: Thomas A. Gardner, 5608 South Foresthill Street, Littleton, CO, 80120, US

(21) Appl. No.: 12/460,056

(22) Filed: Jul. 14, 2009

(51) Int. Cl. F03G 7/00

(52) U.S. Cl. 60/721

(57) ABSTRACT

This invention relates generally to energy and more particularly to a method, hitherto unknown, to create kinetic energy of a body of mass. It is excessively well know in classical physics that energy can not be created or destroyed. The word create as used herein shall mean to make present about the surface of the earth energy which was previously was not present. The source of the kinetic energy shall be due to a combination of earth's gravity effects acting through a displacement. The new use and method for creating kinetic energy shall be by situating an EPICYCLOID ROLLING RESISTANCE ABATEMENT MEANS (U.S. Pat. No. 4,878,525) on an inclined surface on or about the earth's surface. Epicycloid rolling resistance abatement means art provides means of rolling resistance abatement for vehicle wheels by means of sequaciously storing and releasing energy by way of compression springs attached in a recessed manner to the periphery of a vehicle wheel. The new use and method would still render the same results if the wheel were extricated from a vehicle. The present new use invention whilst in operation incurs motion by the influence of gravity and provides a method by a unique combination of the elements described above for the acquisition of an increase of kinetic energy hitherto unknown. Subsequently, the created kinetic energy could be converted to electrical energy or other form of energy. The energy yielded may also be stored for a later and more timely use. This prior art discloses the operation with a multiplicity of vehicle wheels cooperating and communicating with synchronisation optimization. This wheel apparatus art shall constitutes the structural form of the present invention new use and method and the said form shall be situated on an inclined plane and the said inclined plane shall reside in a gravitation field and be subjected to effective forces appertaining thereto in a predetermined and pre-positioned manner whereby the wheel apparatus is impels force resulting in kinetic energy.

### CROSS-REFERENCE TO RELATED APPLICATIONS

None.

### STATEMENT REGARDING FEDERALLY SPONSORED RESEARCH OR DEVELOPMENT

This application does not involve any rights to inventions made under federally sponsored research and development.

### BACKGROUND OF THE INVENTION

This invention relates generally to energy and more particularly to a method, hitherto unknown, to create kinetic energy of a body of mass. It is excessively well know in classical physics that energy can not be created or destroyed. The word create as used herein shall mean to make present about the surface of the earth energy which was previously not present. The source of the kinetic energy shall be due to a combination of earth's gravitational effects acting through a displacement.

Hydrocarbon energy sources are limited, expensive and pose environmental hazards. Nuclear power plants introduce long term waste material hazards as well as potential site security issues. Hydroelectric energy by means of dam building is constrained due to environmental concerns as well as the limitation of acceptable site locations. Solar, geothermal, and wind energy, although promising, have yet to meet economic breakeven without financial subsidies. Solar energy is intermittent requiring daylight and cloudless skies. Wind energy is also intermittent because the wind occasionally does not blow.

The latest alternative energy trend is to split the water molecule into hydrogen and oxygen whereupon the hydrogen subsequently may be used as fuel. Clean energy depends on the source of the energy. If hydrogen is clean energy, the means for obtaining the hydrogen must be taken into consideration. In other words, if the hydrogen is obtained by means of fossil fuels, the negative environmental impacts remain. Due to these limitations additional alternative energy sources are meritorious of consideration.

Common to all energy production is a source from which that energy must originate. The typical prevailing scientific view is the earth core heat is due to the historic remnants of meteorite strikes dating back for the past four and a half billion years ago. The impact velocity is converted to heat as matter coalesced over billions of years. Other theories suggest there is radioactive decay at the core generating heat in addition to the historic remnant heat. These theories or a combination thereof may very well be true but additionally the weight of the Southern Alps mountains in New Zealand generally opposes the European Alps also contribute to earth's core heat over time. This center force process is similar to the sun but gravitation on the earth results in pressure and heat and is not of sufficient magnitude to induce nuclear fusion. The force of gravity is omnipresent and ubiquitous about the earth's surface and available regardless whether the sun is shining or the wind is blowing.

A method to mitigate rolling resistance is disclosed by Gardner (U.S. Pat. No. 4,878,525).

Gardner's art provides means of rolling resistance abatement for vehicle wheels by means of sequaciously storing and releasing energy by way of compression springs extended beyond the preifrery of wheel and attached in a recessed manner to the periphery hub of a vehicle wheel. Gardner's art also discloses the operation with a multiplicity of vehicle wheels cooperating and communicating with synchronisation optimization. This wheel apparatus art constitutes the structural form of the present invention and method and the form shall be situated on an inclined plane and the said inclined plane shall reside in a gravitation field and be subjected to the gravitation force appertaining thereto.

In an ideal world, that is to say a world without friction, the concept of conservation of energy is well known and generally accepted throughout the scientific community. Simply stated, in a region of space, also known as a control volume, the quantity of energy cannot be created nor destroyed but merely transformed into different forms. For purpose of the present art the region of space selected shall included the planet earth in its entirety. The forms of energy of an object are usually categorized into kinetic energy, -that is to say energy due to motion, potential energy—that is to say energy related to position as situated in the proximity of a gravitational field, and internal energy-energy represented by molecular energy which may exist in sensible, latent, chemical, and/or nuclear forces. A compression helical spring which in a state of compression can be considered a form of internal stored energy. Energy may change forms but the overall total quantity of energy in a closed volume of space remains the same.

An example of energy transformation would be the release of a basketball situated under the influence of a gravitational field. Upon release the basketball would incur an increase of kinetic energy while undergoing a decrease of potential energy. Upon contact with the floor, the kinetic energy would be transformed into internal energy due to the temporary increase in air pressure within the ball. Subsequently, the air pressure would be restored to the original pressure upon rendering the ball in an upward motion—in other words the bounce of the ball—and the ball would acquire kinetic energy in the opposite, upward direction until the ball returns to the original position whereat the kinetic energy would be transformed to potential energy whence and whereat the ball would come to an instantaneous stop. In an ideal, frictionless world the energy transformation process occurs from potential, to kinetic energy, to internal energy then back to kinetic energy, and subsequently back to potential energy and this process would continue indefinitely.

Another scenario, is the condition while the basketball is at rest on the floor whereupon the basketball does not transform energy, but does provide weight as a force. The basketball has the property of weight. This force is transferred to the earth's lithosphere resulting in a slight nearly imperceptible geological pressure. This pressure is not present when the basketball is in motion or at the top of the bounce arc.

And yet still another scenario, is the condition when the basketball is placed on an inclined plane and subsequently rolls down the plane. The basketball acquires kinetic energy while concurrently still processing at least a portion of the property of weight.

The theory of general relativity requires physical laws apply regardless of the frame of reference within which the experiments are performed. The perspective of interest herein is within general relativity and is known as the PRINCIPLE OF EQUIVALENCE. The principle contends there is no discernible difference, from the perspective of physical laws, between the effects of a gravitational frame of reference, when compared to an accelerating frame of reference. Einstein's principle is also known as THE EQUALITY OF GRAVITATIONAL AND INERTIAL MASS and is:

“We imagine a large portion of empty space, so far removed from stars and other appreciable masses, that we have before us approximately the conditions required by the fundamental law of Galilei. It is then possible to choose a Galileian reference-body for this part of space (world), relative to which points at rest remain at rest and points in motion continue permanently in uniform rectilinear motion. As reference-body let us imagine a spacious chest resembling a room with an observer inside who is equipped with apparatus. Gravitation naturally does not exist for this observer. He must fasten himself with strings to the floor, otherwise the slightest impact against the floor will cause him to rise slowly towards the ceiling of the room.

To the middle of the lid of the chest is fixed externally a hook with rope attached, and now a “being” (what kind of a being is immaterial to us) begins pulling at this with a constant force. The chest together with the observer then begin to move “upwards” with a uniformly accelerated motion. In course of time their velocity will reach unheard—of values—provided that we are viewing all this from another reference-body which is not being pulled with a rope.

But how does the man in the chest regard the process? The acceleration of the chest will be transmitted to him by the reaction of the floor of the chest. He must therefore take up this pressure by means of his legs if he does not wish to be laid out full length on the floor. He is then standing in the chest in exactly the same way as anyone stands in a room of a house on our earth. If he releases a body which he previously had in his hand, the acceleration of the chest will no longer be transmitted to this body, and for this reason the body will approach the floor of the chest with an accelerated relative motion. The observer will further convince himself that the acceleration of the body towards the floor of the chest is always of the same magnitude, whatever kind of body he may happen to use for the experiment.

Relying on his knowledge of the gravitational field (as it was discussed in the preceding section), the man in the chest will thus come to the conclusion that he and the chest are in a gravitational field which is constant with regard to time. Of course he will be puzzled for a moment as to why the chest does not fall in this gravitation field. Just then, however, he discovers the hook in the middle of the lid of the chest and the rope which is attached to it, and he consequently comes to the conclusion that the chest is suspended at rest in the gravitation field.”

The present new use invention should be viewed from another reference—a body which is not being pulled by rope. We further would like the man in the chest that resembles a room in which an experiment by the method disclosed of the present new use invention, that is to say, with an inclined plane and the embodiment of the present new use invention and method which resides within the room. Placement of an inclined plane within the chest is not difficult to envision.

The principle of equivalence is referenced herein in order to disclose the operation of the present invention without the encumbrances of presuppositions and preconceptions of gravitational effects on rigid and none rigid bodies, in other words, the transformation from potential energy, then to kinetic energy and subsequently to internal energy along with the reversed energy processes without regard to the earth's increase of internal energy. Although, Einstein dismisses the means of the pulling force by stating “ . . . To the middle of the lid of the chest is fixed externally a hook with rope attached, and now a “being” (what kind of a being is immaterial to us) begins pulling at this with a constant force . . . ” The force he dismisses as immaterial is the enabling force of the present new use invention.

Adherence to the energy conservation law is thereby accomplished in that the earth's internal energy is decreased by a corresponding increase of the kinetic energy created. The environmental impacts are internal to the earth core heat and generally external relative to the biosphere. Specifically, the earth core heat is reduced.

### BRIEF SUMMARY OF THE INVENTION

The present new use invention whilst in operation under the influence of gravity provides a method by a unique combination of the elements described above for the acquisition of an increase of kinetic energy hitherto unknown. Subsequently, the created kinetic energy can be subsequently converted to electrical energy or other forms of energy by excessively well known utility arts. The energy yielded may also be stored for a later and more timely use such as converting the created energy via momentum converters to electrical energy then to chemical energy by way of electrolysis of water into hydrogen and oxygen whereby the hydrogen can be stored in a containment vessel.

### DETAILED DESCRIPTION OF THE NEW USE AND METHOD OF THE INVENTION

A new use and method for creating kinetic energy using at least one wheel fitted with an EPICYCLOID ROLLING RESISTANCE ABATEMENT (U.S. Pat. No. 4,878,525) means comprising the steps of situating the wheel fitted with an EPICYCLOID ROLLING RESISTANCE ABATEMENT means upon an inclined plane and allowing said EPICYCLOID ROLLING RESISTANCE ABATEMENT to roll down the inclined plane under the influence of gravity subsequently realizing an increase of kinetic energy beyond the kinetic energy which would be realized without being fitted with said EPICYCLOID ROLLING RESISTANCE ABATEMENT means.

A preferred embodiment would be to extricate the wheels from the vehicle and for the sake of wheel stability firmly attach two wheels such that a solid spool apparatus is formed with the helical springs as disclosed cooperating and communicating whilst on the inclined surface. The prior art indicates the springs are radially attached which preludes torque effects. The contact surface of the spool apparatus and the springs shall be configured such that slippage is minimized using excessively well known traction art. Traction is especially important during the relaxation of the springs whereby the previously stored compression energy releases such that maximum thrust is available to impel the spool apparatus forward.

Accordingly, to compare classical physics to the new use invention and method let us first retract the spring elements from the periphery of the spool edges whereby the spool might roll down an inclined plane in a the same fashion as a monolithic wheel and axle. If we were to construct an inclined plane or ramp of around 25,000 miles and at a height of 25 miles the resulting gradient would be 0.001 and the spool apparatus with retracted spring elements in a frictionless environment would travel the ramp distance in about 25 hours with a final velocity of just under 3000 feet per second resulting in an increase of kinetic energy and a corresponding decrease in potential energy easily calculated using familiar classical physics. The ramp is about the size of the earth's diameter and ramp might have a maximum starting height at the north pole of 25 miles and be at the a height of 12.5 miles at the south pole and subsequently be at sea level upon returning to the north pole. It is also not difficult to imagine the “spacious chest” as described in the principle of equivalence, were it spacious enough, could also accommodate a decurved ramp of the aforesaid geometries.

Contrasting the classical physics with the prior art, that is to say, with the springs extended beyond the spool edges whereby energy is stored and released in a sequacious manner is now disclosed. From a physics perspective this is to say that whilst the spring is in the compression stage the spool apparatus impedes the kinetic energy whilst storing internal energy. This stored internal energy is subsequently released via spring decompression and the energy returned such that the classical physics model conservation of energy is expected under ideal or frictionless conditions. However, two events must also be considered.

First, the weight of the spool apparatus is subjected to upward forces during both the compression and decompression phase. The combined effect of the upward forces are such that the effective weight, that is to say, the weight component, normal to the inclined plane, is diminished. As example, should the upward combined normal components of the springs or a multiplicity of springs during both the compression and decompression phase be configure to be fifty per cent of the spool apparatus weight the effective weight would be only fifty per cent whilst on the same ramp gradient. The impelling force resultant component would also be reduced by fifty per cent. The effective gradient adjusted g force would be reduced and the spool apparatus trip would take longer than the 25 hours trip had there been no springs in operation. This conflicts with the name of the invention which is to is to create kinetic energy.

The second event to be considered is that should the spool apparatus be configured per the prior art then the spring would incur a buckling event that bifurcated the compression and decompression cycles. This buckling event would occur while the center of gravity of the spool apparatus whilst in motion. The result of the buckling occurring concurrently with the displacement of the center of gravity renders the decompression of the spring's stored energy in a direction that is asymmetrical to the forces required for the increment compression cumulatively added resultant component. In other words, the center of gravity of the spool apparatus is displaced during the buckling event. Although the compression impedes motion the decompression is in an asymmetrical direction relative to the compression and thus propels the spool apparatus. The net result of compression/decompression cycle is such that there is an acceleration of the acceleration due to gravity. Although the diminished effective weight of the spool apparatus tends to decrease kinetic energy the acceleration of the acceleration due to gravity increases the kinetic energy and should the apparatus be located on the ramp for a sufficient period of time, the increase of acceleration which propels overcomes the diminished effective weight of the spool apparatus which supplies the acceleration. The net effect is an acceleration beyond that which would be expected of a spool apparatus without springs operating as such. The net effect is an increase of velocity of the apparatus. The kinetic energy which is present beyond that energy which expected by classical physics is the created energy. The created kinetic energy is the art. The created energy is the disclosure. The created energy is the novel. The created energy is the new. The created energy is the invention. The created energy is the discovery. The created energy is manifest and thus unconcealed. The created energy is revealed. The created energy is the utility.

Although the exact scientific principle is unknown, it is believed the increase of velocity is due to the overall cumulative weight reduction of the spool apparatus whilst in operation. A thought experiment which demonstrates this is; if one were to envision a very large helicopter which was able to provide lift to Washington Monument by an imaginary hook whereof the weight of the Monument was reduced by fifty per cent for a duration of one day. During that day the helicopter would expend fuel so as to un-weight the monument. It is believed that the energy conservation principle would required the heat generated at the core of the earth or thereabouts would be reduced by a exact energy equivalent consumed within the helicopter to un-weight the monument. There would be no change in potential energy because the monument position is unchanged relative to the gravitational field. There would be no change in kinetic energy due to the fact the velocity did not change because the monument was not moved or displaced. After the twenty four hour period earth core heat reduction is required to be reduced by the an energy equivalent of the fuel consumed by the helicopter under ideal or frictionless conditions.

The question then arises what historically became of the core heat in view of the Washington Monument has been there for well over a hundred years. It is assumed the heat is dissipated via volcanos, ocean floor spreading, vulcanism activity, earthquakes, geologic subduction processes, hydro-thermal venting among a plethora of other geology processes. These same processes are used to dissipate heat due to the weight of the oceans, continents, and atmosphere. The new use and process disclosed herein would produce similar effects whist in operation for the 25 hour period. One could envision geothermal energy in part as becoming due to the weight, pressure and time of the earth's surface crust. The weight of the objects on the earth is the CAUSE then geothermal energy is the EFFECT. If the weight as CAUSE is interdicted by means of the spring displacements then the geothermal energy is not EFFECTED. The spring displacements provide the means to transfer energy to the spool apparatus. The weight is the enabling force and must be present in order for the method to operate successfully. In other words, the new use and method will not work on the International Space Station due to a lack of enabling force.

The portion of kinetic energy increase due to the present new use invention may subsequently be converted to electrical energy by means of momentum converters which is an excessively well know art. Wheels could be extricated from the vehicles as wheel consist of mass and hence have weight. Momentum converters may or may not be mounted on the vehicle or arrange on the vehicle wheels. Momentum converters can be used to enable electrical generators which could produce electricity which could subsequently be used for electrolysis to separate water molecules into the oxygen and hydrogen components whereupon the hydrogen could be compressed and stored in steel containers and placed upon a retailer shelf as fuel ready for consumer purchase whereupon the consumer could use the fuel in work producing, fuel consuming, engines for good and useful purposes such as providing water supply in remote regions of the world. Although a 25,000 mile inclined plane ramp as example was disclosed herein shorter ramps could accomplish the same objective. Although a spool apparatus was described herein a wheel and vehicle could be used to accomplish the same task upon communicating and cooperating an appropriate arrangement. Operation and method may use a multiplicity of predetermined and propositioned inclined planes at a multiplicity of sites. Inclined planes may or may not be inclined. The plane may not be a plane at all but may be a curved surface. Operation and method may use a multiplicity of predetermined and propositioned EPICYCLOID ROLLING RESISTANCE ABATEMENT means. Operation and method may use a multiplicity of predetermined and propositioned vehicle wheels. Operation and method may use a multiplicity of predetermined and propositioned vehicles. Operation and method may use a multiplicity of predetermined and propositioned methods such as rumble strips as means to preclude spring slippage whilst in operation. The operation and method may be placed in a vacuum chamber wherein air resistance is mitigated providing means to limit friction and enhance the invention's intent. The materials for the various components shall be consistent with material use for wheels, springs, rigid planes, and vehicles if vehicles are incorporated by those skilled in the appropriate mechanical arts.

While the above description contains many specifics, the reader should not construe these as limitations on the scope of the invention, but merely as exemplifications of preferred embodiments thereof. Many other possible variations are within the scope of the present invention. Shape, dimensions, alternative materials, alternative elements, adjustments of mechanisms of the various embodiments are within the ability of anyone skilled in the art of compression elements, springs, travel ways, inclined planes, inclined planes with curved surfaces, surface ramp construction, EPICYCLOID ROLLING RESISTANCE ABATEMENT, rotational transmission means, vehicles and vehicle wheels. Accordingly, the scope of the invention merits should be determined by the appended claims and their legal equivalents, and not by the examples which have been given.

I claim:

1. A method of creating kinetic energy comprising placement of epicycloid rolling resistance abatement means upon an inclined surface in a manner to increase kinetic energy.
